(19) United States
(12) Patent Application Publication
(10) Pub. No.: US 2020/0201829 A1
(43) Pub. Date: Jun. 25, 2020

(54) SYSTEMS AND METHODS FOR COMPILING A DATABASE

(71) Applicant: Infosum Limited, Basingstoke (GB)

(72) Inventors: Nicholas Halstead, Hook Hampshire (GB); Eike Spang, Basingstoke (GB)

(21) Appl. No.: 16/638,231

(22) PCT Filed: Aug. 10, 2018
(86) PCT No.: PCT/EP2018/071823

§ 371 Date: Feb. 11, 2020

(30) Foreign Application Priority Data
Aug. 11, 2017 (GB) 1712948.7

(51) Int. Cl. G06F 16/21; G06F 16/9038; G06F 8/41

(52) U.S. Cl. CPC G06F 16/211; G06F 8/41; G06F 16/9038

(57) ABSTRACT

A method of compiling a database of entries, the method comprising: (a) receiving an origin set of data entries from an origin dataset, each entry comprising a category indicator and at least one data field containing data of a first category in a first source format; (b) for each entry of the data of the first category, transforming the source format into at least one representation which represents the data of the first category with a different precision to the source format; and (c) storing the data entries in a recipient database, each data entry comprising the category indicator and multiple representations of the data, including the at least one transformed representation.

### FIELD

The present invention relates to accessing databases, and particularly but not exclusively to accessing multiple independent databases to provide a response to a single query having multiple expressions.

### BACKGROUND

It has long been the case that it has been possible to query databases holding data to provide a response to the query. Queries are run on databases to find a match for the information being requested responsive to the query. For example, a user providing the query might want to know how many entries in a particular database satisfy a particular requirement, for example, an age range or gender requirement. There are numerous technologies available to handle this. It is becoming an increasing requirement however to use more than one database to satisfy a single query. This can be for multiple reasons. Queries may be more complex, and have more expressions requiring a match. Some expressions may be fulfilled by one database, whereas other expressions may relate to information or data held in a different database. Existing techniques for satisfying a query with multiple expressions where those expressions need to be fulfilled from different databases are not wholly satisfactory.

According to one technique, the two independent datasets are firstly merged together so that they exist as a single dataset which can then be queried with the multiple expressions. This procedure can require the transfer of large amounts of data, and a complex merging exercise at the receiving end.

Sometimes, databases are available within a single “system” such that they can be in direct communication. A technique exists to query across such databases. For this technique you have to give full read access to the databases to allow those queries. So there is now way of controlling the queries that are made on individual databases and therefore there is now way to keep the data secure. This is why the technique is only suitable for databases which are held on the same “system”. The technique is not suitable for databases held by independent owners.

Thus, in one known arrangement, data is collected into a single database. This puts limitations on how the data can be joined and analysed. In another technique, data is moved either physically or over the Internet, exposing it to a variety of security risks.

Further disadvantages of the known techniques include the fact that data quickly becomes less valuable and useful as it goes out of date. This means that where data is collected into a single database from multiple independent databases, this has to be an ongoing procedure. Increasingly, privacy restrictions surrounding data means that providing data from one database into a combined database can come with restrictions around privacy issues.

### SUMMARY

One issue with prior art database joining techniques is that the way in which the data is stored in each database (e.g. the data or indexing format etc.) may be different across the multiple databases. Prior art techniques look for exact matches between entries in databases (e.g. matching keys or IDs) in order to perform this joining, which means that some or all of the entries may not be merged. This can significantly reduce the “quality” of the merge.

Embodiments of the present invention which are described in the following address some or all of these issues. In general terms, this invention provides two aspects, a first aspect in which “mirror” (or recipient) databases are compiled from origin data sets, and a second aspect in which a query is run using the “mirror” database rather than the origin data sets. A recipient database can be generated by “reading in” entries from an origin dataset and storing them each in accordance with at least two different representations.

Hence, according to a first aspect disclosed herein, there is provided a method of compiling a database of entries, the method comprising: (a) receiving an origin set of data entries from an origin dataset, each entry comprising a category indicator and at least one data field containing data of a first category in a first source format; (b) for each entry of the data of the first category, transforming the source format into at least one representation which represents the data of the first category with a different precision to the source format; and (c) storing the data entries in a recipient database, each data entry comprising the category indicator and multiple representations of the data, including the at least one transformed representation.

In embodiments, the multiple representations are predefined as part of a global schema for compiling several recipient databases, wherein the first category of data is provided in the multiple representations in each of the recipient databases.

In embodiments, each recipient database is compiled from its own respective origin set of data entries.

In embodiments, the multiple representations of the data in the recipient database includes the source format.

In embodiments, none of the multiple representation of the data in the recipient database matches the source format.

In embodiments, the different precision is a lower level of precision, and data entries stored in the recipient database according to the multiple representations are stored in association with a precision indicator for each representation.

In embodiments, the at least one category indicator comprises an age field and the multiple representations comprise at least some of: a range of values; a minimum or maximum threshold; and a single age value.

In embodiments, the multiple representations comprise multiple different ranges.

In embodiments, the category indicator comprises a salary field.

In embodiments, the multiple representations include an indication of the data entry value as a floating point or integer number.

In embodiments, the multiple representations include an indication of whether the data entry is greater than or less than a threshold value.

In embodiments, the multiple representations include an indication of a range of values within which the data entry lies.

According to a second aspect disclosed herein, there is provided a computer configured to compile a database of entries, the computer comprising a processor arranged to execute a computer program which, when executed by the processor, carries out a method according to the first aspect.

In embodiments, the computer comprises a memory in which is stored a configuration file defining a global schema which defines the multiple representations.

According to a third aspect of the invention there is provided a database comprising computer memory holding a data structure in the form of a plurality of data entries for respective entities, the data entries having been transformed from an origin dataset, wherein each data entry comprises a category indicator indicating category of data in a data entry, and multiple representations of the data in that category, including at least one representation transformed from but not matching data in that category in the origin dataset, each representation stored with a precision indicator denoting the relative precision of the representation compared with the data in that category in the origin dataset.

The data structure of such a database supports a method of querying the database, the method comprising extracting an expression from an input query, the expression having a query format and pertaining to a category, selecting one of the multiple representations in that category, comparing the expression with the selected one of the multiple selected one of the multiple representations and generating an output of entities where the data in that category matches the expression in the query format.

Selecting one of the multiple representations can be based on the precision indicator. According to a further embodiment, the query format of the expression can be transformed into multiple representations, with a respective accuracy associated with the transformation into each representation. Selecting one of the multiple representations can be based on a combination of the precision indicator and the accuracy of transformation.

The multiple representations can also be used for generating output. Outputs are generated in the form of aggregated results organised by bins, with bin boundaries. According to one embodiment a user can select these bin boundaries. According to another embodiment, the bin boundaries may be automatically selected and in that case that they may be selected based on the most appropriate one of the multiple representations in the data category for which the output results are aggregated.

The recipient databases may be referred to as “mirror” databases even though in fact the entries may include fields for the “same” data which differ in precision from the origin dataset.

According to a fourth aspect disclosed herein, there is provided a method of querying a database according to the third aspect, the method comprising: extracting an expression from an input query, the expression having a query format and pertaining to a category; selecting one of the multiple representations in that category; and comparing the expression with the data in that category for the data entries, and generating an output of entities where the data in that representation of the data category matches the expression.

In embodiments, the method further comprises a step of transforming the expression into each of the multiple representations and determining an accuracy of transformation for each representation, where in the step of selecting the one of the multiple representations comprises using the precision indicator for that representation and the accuracy of transformation of the input query expressions.

In embodiments, the step of generating outputs comprises generating data in respective bins, wherein the boundaries of the bins are selected based on the selected representation.

In embodiments, a user who provided the input query selects bin boundaries for aggregating output results of the query.

In embodiments, the method further comprises proceeding with the query if a precision indicator associated with the selected representation is below a threshold value and otherwise not proceeding with the query.

In embodiments, the method further comprises returning results based on the selected representation of the multiple representations, with an error indicator based on the precision indicator of the most closely matched representation.

For a better understanding of the present invention and to show how the same may be carried into effect, reference will now be made by way of example to the following drawings.

### BRIEF DESCRIPTION OF DRAWINGS

FIG. 1 is a schematic diagram illustrating a data joining system at a high schematic level;

FIG. 2 is a diagram illustrating the method of data joining;

FIG. 3 is a schematic diagram illustrating a specific example where customers' transaction data is joined with their corresponding demographics data from two independently controlled databases;

FIG. 4 is a schematic diagram illustrating a possible architecture for implementation of some embodiments;

FIG. 5 is a flowchart illustrating processes carried out at a central controller;

FIG. 6 is a schematic diagram illustrating the flow of FIG. 5;

FIG. 7 is a more detailed architectural diagram of a computer system for accessing multiple independent databases;

FIG. 7a is an example of the configuration file as illustrated in FIG. 7;

FIG. 7b is an example of a configuration table;

FIG. 8a and FIG. 8b are diagrams illustrating filtering expressions with logical operators;

FIG. 9 is a diagram illustrating the process of querying multiple drones with a single joining key;

FIG. 10 is a diagram illustrating the process of querying multiple drones with a single joining key;

FIG. 11 shows an example output of a user screen;

FIG. 12 shows another example output of a user screen;

FIG. 13 shows yet another example output of a user screen;

FIG. 14 shows a schematic of a network of mirror databases;

FIG. 15 shows another example of mirror generation;

FIG. 16 shows yet another example of mirror generation.

FIGS. 17a to 17c illustrate use of the multiple representations for querying;

FIG. 18 is a flowchart showing the querying process with multiple representations; and

FIG. 19 illustrates an example overall system architecture in accordance with embodiments of the present invention.

### DETAILED DESCRIPTION

Nowadays every company holds valuable data, for example concerning attributes of consumers or potential consumers who may wish to access that data. Sharing customer data among different companies creates complex privacy and legal issues, as the data contained in customer records may be shared involuntarily. The problem is exacerbated by the fact that different departments within the same company, or among different companies may store data at different locations, and thus moving and selling data across sites poses security risks that may result in value leakage. Furthermore, different companies' storage formats are often not compatible and therefore increases the complexity in sharing customer data by querying the databases owned and operated by the various companies.

The present invention solves this problem by providing methods of constructing “mirror” databases which store data entries according to multiple data formats or representations, and methods of accessing such mirror databases to query the data stored therein.

A method is provided of storing data in which a set of data entries are sourced from a first dataset (e.g. stored in an “origin” database) and stored according to a multi-format (or multi-representation) schema in a recipient database. The original data entries, as found in the first dataset, are of a first format (source format) and are each converted into at least two storage representations (at least one of which is different from the first format) for storing in a “mirror” database. That is, a mirror database is provided in which data entries are each stored according to two (or more) different predefined representations of a data schema.

The term “dataset” is used herein to refer to any set of data, whether stored on a single memory device (e.g. a server) or across multiple memory devices (e.g. multiple servers). Similarly, the term “database” is used to refer to a data construct comprising multiple data entries, which may be stored at one or more memory locations (potentially at different geographical locations such as different data centres). In the art, the term “database” implies a structured ordering of the data wherein fields are held in association with identifiers (generally in rows and columns, but also possibly as other representations such as graphs, time series etc.). Other datasets are possible, which do not necessarily conform to a database paradigm. The term “database” may be used herein to denote a database or a dataset.

Here, the term “data schema” is used to refer to the particular ways in which data can be represented. For example, age values can be stored as an integer (number of years or, less commonly, months or days), as a date of birth value, or can be represented as an age range (e.g. 25-30 years old). Conversions from a source format into different representations are possible, but this conversion can result in loss of information. To address this, the present system provides a data schema in which data of a particular category (e.g. age) is stored in more than one representation in the “mirror” database. That is, the single origin format is converted/transformed into multiple recipient representations.

Different representations of data have different precision values. Here, “precision” refers to the specificity with which the data is given. For example, an age given as an integer value has a higher precision than the same age represented as a range—e.g. “27” is more precise than “25-30”—because the range could refer to any of the integers 25, 26, 27, 28, 29 or 30, whereas the integer “27” refers specifically to that value. Thus, when converting source formats to different representations there will be a difference in precision, and information will be lost. This is noted herein by a precision indicator which indicates the relative precision of the “new” representation compared to the original format.

Where many “mirrors” are created for querying and joining, there is a “global” data schema, i.e. same sets of multiple representations across multiple mirrors, for each category of data. The global schema may define a different set of representations for different data categories. In other words, the particular representations which are to be used in the mirror (as specified by the global schema) may be category-specific in that the multiple representations to be used for storing data entries of a first category may be different from the multiple representations to be used for storing data entries of a second category different from the first. As an explicit example, “salary” data and “revenue” data will both take the form of financial figures (i.e. monetary values), but the global schema may define that the representations (e.g. the ranges of the bins) should be different for salary values and revenue values.

When converting the origin data from its origin format to the recipient representations in the global schema, information might be lost in some or all of the recipient representations. In a case where the origin data is in a representation which matches one of the recipient representations, no information will be lost in that conversion—the precision indicator will be 100%. Also in a case where for example, a representation can be precisely mapped to a unique value (e.g. age in years versus a date of birth or a year of birth) the precision indicator is 100%. However, where the representation is changed, information will be lost. For example, if the global schema demands a single value representation, and the origin representation is a range, then a mid-value of the range may be taken as the single value. The precision indicator would depend on the size of the range—in a larger range more information would be lost than in a smaller range.

When a single value is converted into a range, this is 100% precise because precision defines how many correct values are in a ‘bucket’.

In embodiments, there are a network of “mirror databases” (also called “recipient databases”) which store data from a respective network of origin databases in a similar manner to that described above. That is, each mirror stores copies of data entries from its respective origin dataset but converted to each of the representations defined in the global schema.

That is, a first mirror database receives data entries from a first dataset and stores them in a (potentially, for each individual entry) modified form which conforms to the global schema, and a second mirror database independently receives data entries from a second dataset and stores them in a similar manner. Hence, the entries in the two mirror databases conform to the same schema which, as outlined above, increases the quality of knowledge returned when querying the two databases together—because the entries are now comparably formatted. Note that it is not necessary that the keys in the first database match the keys in the first mirror. It is sufficient that the mirror stores the (modified) version(s) of the data entries in a searchable manner—whether or not the mirror data can be directly related (by a matching key) to the “original” entry in the database is not important, as the knowledge gained from querying the mirror does not rely on this. This is not excluded however, and it may be preferable for the mirror to store the data entries in association with the original key, i.e. the key used in the raw database (or an easily convertible version of it). When conforming the data to the global schema, the keys are noted and logged in a drone (described in more detail below).

The global schema has categories for data and defined keys. In some embodiments the keys may also be transformed.

In the below, the general procedure for querying across multiple databases is described, followed by a description of the generation of mirror databases and their use to improve upon this querying.

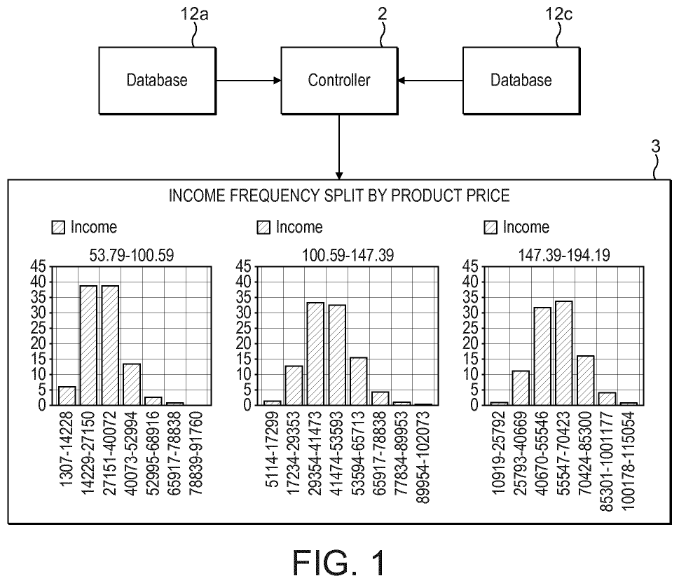

FIG. 1 is a schematic diagram of a technique for joining databases (or datasets). Reference numeral 12a denotes a first database (e.g. a database of a financial organisation) which holds certain attributes within its records (entries). Reference numeral 12c denotes a second database (e.g. a database of a retail organisation) which holds certain attributes within its records (entries). The attributes in one database may be different to the attributes in the other database. Some entities may exist in both databases, and the challenge is to combine knowledge from both databases by joining data in a fully privacy compliant way without any records leaving each company's data centre. Reference numeral 2 denotes a controller which provides such a data joining service. An example output graph visible to a user is denoted by reference number 3; in this example it provides information on the spending habit of customers categorised by their annual income.

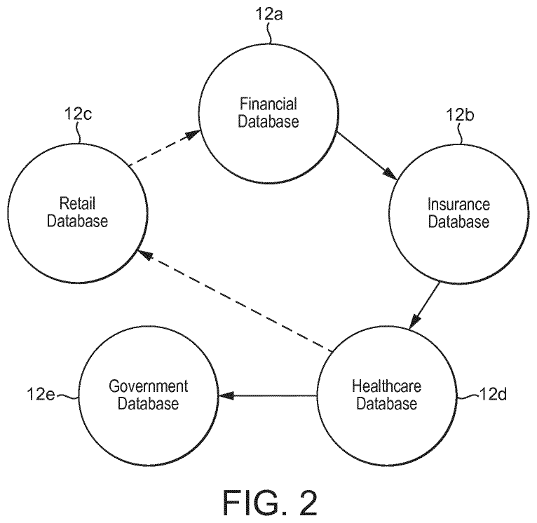

FIG. 2 shows schematically how data joining works for a data joining system with three organisations (Healthcare, Retail and Financial) shown by the dotted arrow, and for four organisations shown by bold arrows (Government, Healthcare, Insurance and Financial). In any case, queries can be created according to the existing datasets at each of the queried companies, in order to fully utilise all of the data available. A suitable filter, such as a list of hashes or Bloom filter, is created from a first query to be applied to one or more of the fields within each dataset to filter entries that does not correspond to a second query. Those matching entries in the dataset are then send back to the cloud as returned data. The joining of combined datasets creates greater knowledge than a single database can offer on its own and in some cases allow new datasets to be created. Common identifiers (or joining factors), such as email address and telephone number, are used to identify data associated with a particular entry across different datasets. In some cases different common joining factors may be use depend upon their availability in the target datasets. The final results as presented to the user can be originated from any one of the queried organisations, but each of the returned data can be configured to meet individual privacy/redaction policies.

Data joining as described herein may be employed to join internal data from databases belonging to the same entity, external data from databases owned by a plurality of entities, or data from databases physically located across different countries. For example when joining internal data, the data joining system according to examples described herein provides a solution to combine datasets that are not allowed to be cross-contaminated, or are intentionally segregated by access restrictions, internal policies and regulations. It is also useful for joining many internal databases that are too large to be managed in a single instance, or combine knowledge of different databases across a large corporation. When deployed to join external datasets, the data joining system allows the companies to benefit from pooling their knowledge and therefrom creates new datasets, as well as to acquire knowledge of sensitive data that would not normally be shared. Furthermore, the data joining system allows data to be sold into newly created market places. In some cases the use of the data joining system overcomes juridical restrictions and allows data to be exported from a particular jurisdiction. The data joining system is also useful for joining datasets that are time consuming to synchronise or technically impractical to move among different countries.

Databases which can be accessed using the data joining service form a data joining network. As more companies subscribe to the data joining network, they each form a node on the network and become a part of a combined dataset that incorporates many small datasets, e.g. the data joining network may act as a central database. Furthermore, there is no limit to the number or size of the combined datasets across the subscripting companies, whilst each of them remain in control of who they wish share their knowledge with.

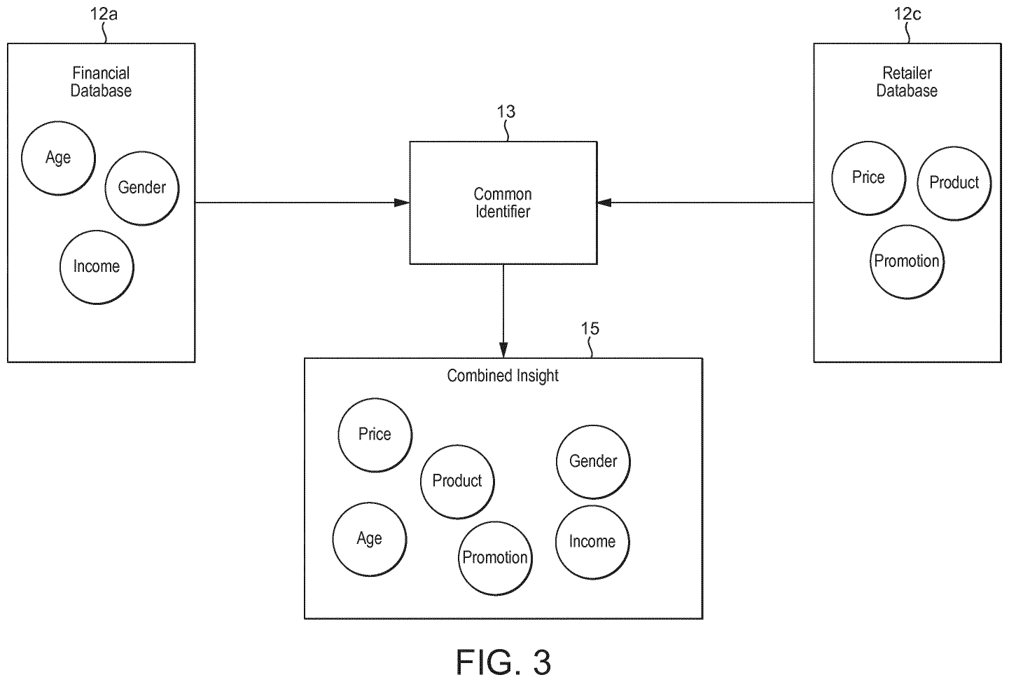

FIG. 3 illustrates a specific example where a retailer cross-examines customers' transaction data and purchase history (e.g. price, product and promotion of past purchases) with their corresponding demographics data (e.g. age, gender and income) from a bank's dataset, using email addresses as a common identifier 13 (or joining factor). This provides a combined insight of customers 15 and allows the retailers to create bespoke promotion strategies for their target customers. For example, the combined dataset between the bank and the retailer reveals which promotions are used most frequently by different aged customers and based thereon tailor promotion strategy.

The solution offers a secure data sharing among different databases. In cases where the returned data is given in statistical form, customer records associated with the returned data never leave the owners' database. Moreover, the statistical data can comply with redaction rules to protect each individual customer's identity. Redaction control can be applied over the whole database or individual data fields.

The controller 2 can be embodied in the ‘cloud’ to provide a cloud service that facilitates data joining. The cloud service stores instructions for data acquisition (e.g. filtering expressions), but not the actual returned data. Moreover the queries can be controlled in real time and so they can be terminated as required.

In terms of access control, each sharing database is given its own set of access control so to allow bespoke control on who they wish share their knowledge with. This prevents accidental sharing of commercial sensitive data that would otherwise be detrimental to the owner of the sharing database. Restriction may also be imposed on queries requesting sensitive combination of fields in the dataset.

The described embodiments allow data from multiple discrete databases to be combined, allowing different owners of databases to consent to mutual use of each other's data without compromising security of their own database or anonymity.

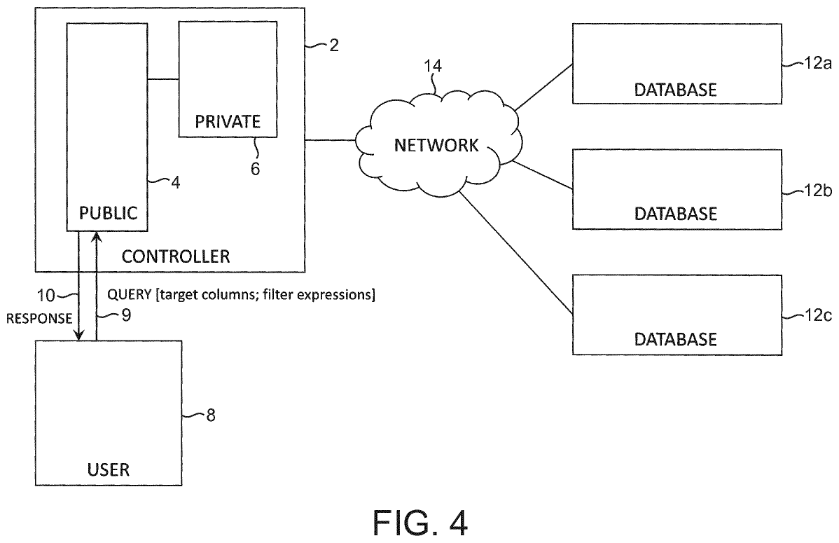

FIG. 4 is a more detailed schematic block diagram of a system in which data from multiple discrete databases can be combined upon receiving a query from a querying user. The system comprises the central controller 2 which has a publically accessible component 4 and a set of private components 6 which implement a data combining process. The central controller can be implemented by software, firmware or hardware or any combination thereof. It could be a single server executing a computer program, or distributed over multiple servers, each running a load computer program, autonomously or in a distributed computing fashion. A user 8 has access to the controller 2 via a public interface, for example, which can be an application programming interface (API) in the controller 2. A user could be in contact with a controller 2 in any other way. Reference to a user herein refers to a user and/or a user device which can be any suitable computer device capable of generating and exchanging electronic messages. In particular, a user can generate a query 9 which he wants to run over multiple databases. That query can be generated by a human user providing manual input at an interface of a computer device, or it can be generated autonomously and automatically by a computer device itself.

Example queries are given later, together with examples of results of the queries delivered to the user.

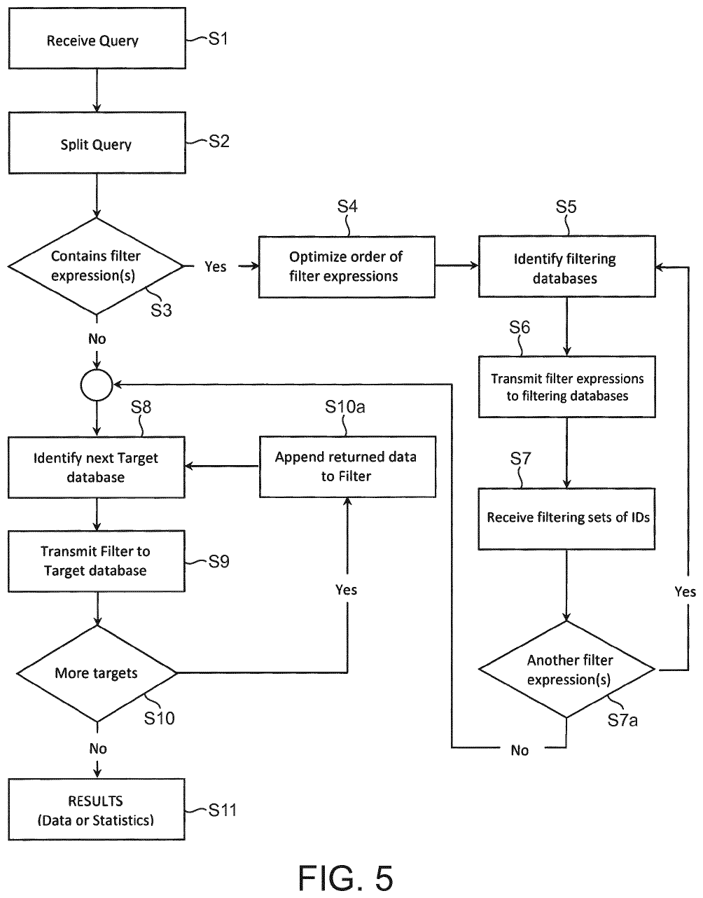

The user 8 receives a response 10 following data combining processes carried out at the controller 2. The response 10 can take the form of a set of target entries resulting from combining the entries in the databases which satisfy expressions in the query. Alternatively, the response 10 can take the form of aggregated data as described in more detail herein, shown for example in a graphical format. The controller 2 is connected to multiple databases 12a, 12b, and 12c. It can be connected via any suitable communication network 14, which could be a private Intranet or public Internet. Before going into a more detailed description of the architecture of the system, the basic principles of the data combining process will now be described. For this, reference is made to FIG. 5.

As illustrated in FIG. 5, the first step of the process is the receipt of a query by the central controller 2 from the user 8, step S1. The query 9 comprises one or more target “columns” to receive data or statistics, and a set of filter expressions which the data or statistics should satisfy. For example, the query could ask for the number of data entries satisfying a certain age range and certain gender specification. Some examples are given later by way of illustration not limitation.

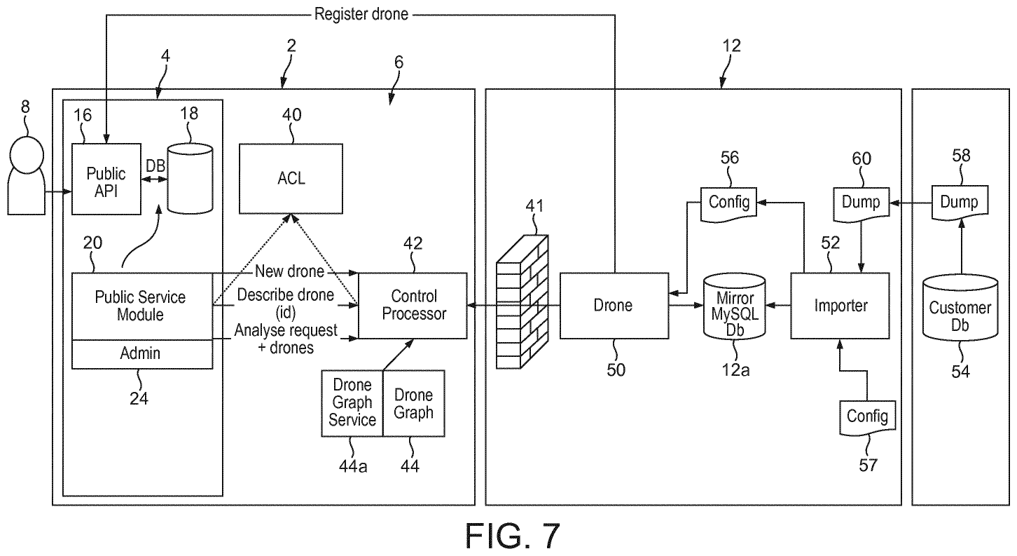

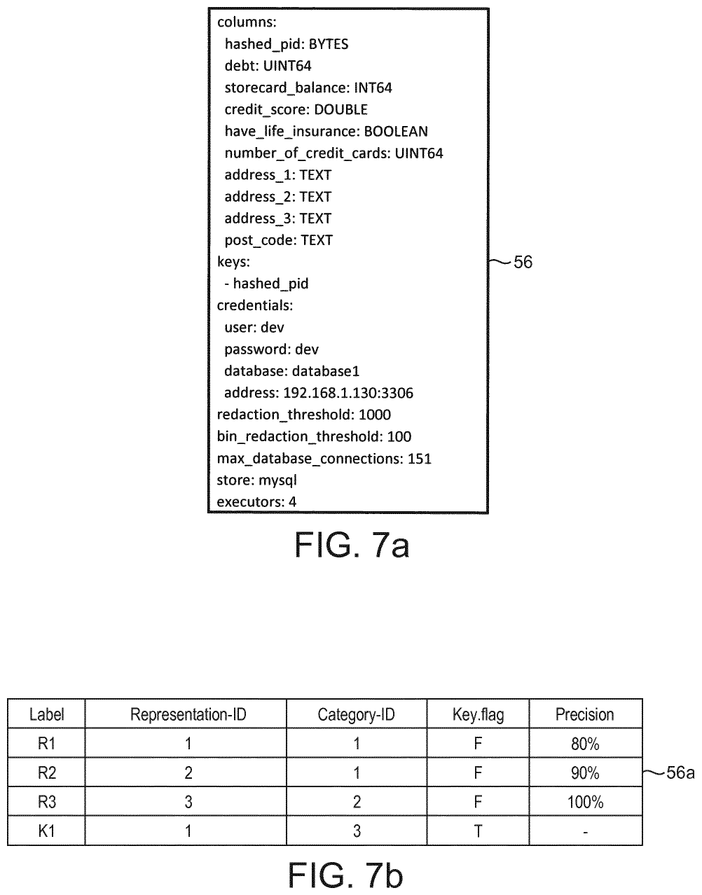

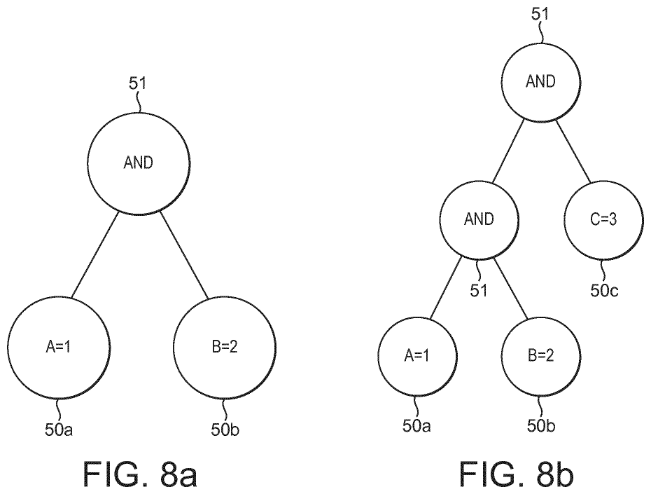

At step S2, the query is split into two queries, which are referred to herein as a filtering query and a target query. Note that this description is given in the simpler context where each queried database holds one representation of data in each category. A more refined version of querying using multiple representations is described later. At step S3, a check is made to see whether or not the filter query contains filter expressions. If it does, the flow moves to step S4 where an order of the filter expressions is optimised. The purpose of this optimisation is to determine an order in which filter expressions are to be submitted to one or more database, as discussed in more detail later. At step S5 filtering databases are identified, each database being selected as the most appropriate database to deal with the particular filter expression. The central controller 2 stores information about all the databases to which it has access to allow it to identify appropriate filtering databases. This information is stored using a drone graph (44 in FIG. 7) described later. Each database is associated with a drone, which serves as a database agent on the software side. For example, the controller can identify which of the databases contains information related to the required filtering expression. At step S6, each filter expression is sent to the most appropriate database. When the first filter expression is sent to the first filtering database, it is run against the database to identify entries in that database matching the terms of the filter expression. For example, if the first required expression is an age range between 18 to 25, a filtering set of identifiers is returned from that database identifying database records satisfying the expression, for example, all the entities in the database aged between 18 to 25. Thus, the age range has produced a filtered set of identifiers. This filtered set can then be transmitted to a subsequent filtering database to act as a filter along with the next filter expression of the query, wherein the next filter expression is compared only to the entries in the database which satisfy the identifiers of the filtered set. Step S7 denotes the function of receiving the filtering sets of IDs, and step S7a the determination of whether there are additional filtering expressions. Once all filtering expressions have been utilised and run against their respective filtering databases, a final filtered ID set is produced. The process then moves to step S8 where a target database is identified for execution of the target query. For example, the target query in this case could be gender-based, for example, identify all females. In step S9, the filtered dataset and the target query are applied to the identified target database where the target query is run only against the identifiers which satisfy the identifiers in the filtered dataset. Note that a single filter expression can be sent to multiple databases, or multiple filter expressions can be sent to a single database. Note also, that in some cases there may be no filtering expressions (step S3) in which case the target query is just passed straight to one or more target database. It is important to recognise that no data records are transferred, only record IDs.

Note that there may be more than one target database, as well as or instead of, multiple filtering databases. Thus, a database could both produce a result set of record data and a filtering set of identifiers for a subsequent query. Note that one expression may be run against multiple databases, for example when more than one database satisfies the expression, but perhaps with incomplete records.

Step S10 checks for whether there are any more target queries or more target databases that need to be addressed with the target query and in the case that they are, the returned data is appended to the filter S10a and steps S8 and S9 run again on the next target database.

When all target databases have been queried, the final results are returned in step S11. Note that the results may be actual data entries, or aggregated statistics, depending on the context in which the method is applied. For example, “real data” could be provided in the results in a company internal implementation, while aggregated statistical results could be provided for public usage, for reasons of security and anonymity.

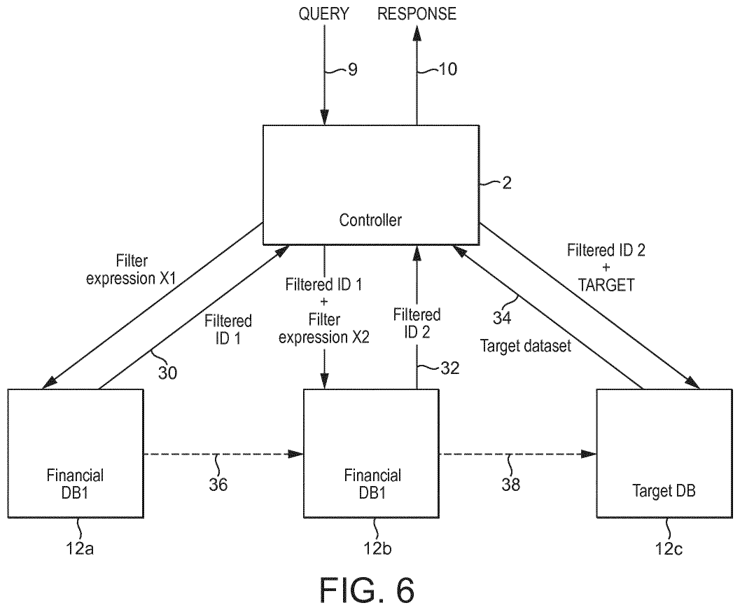

FIG. 6 is a schematic architectural diagram which gives one example of the flow described with reference to FIG. 5. As shown in FIG. 6, a query 9 is received at the controller 2. In this case, the controller 2 splits the query into three separate queries, a first query with a first filter expression X1, a second query with a second filter expression X2, and a third target query with a target expression TARGET. As an example, the first filter expression could be an age range (e.g. between 18 to 25), the second filter expression could be income (e.g. more than £60,000) and the target expression could be gender (i.e. all females). The first query with the first filter expression X1 is sent to the first database 12a of a financial organisation labelled Financial DB1. This database is determined by the controller as being the best database for establishing data entries fitting a certain age range. A filtered set of IDs 1, 30, is returned to the controller 2. This filtered ID set includes record identifiers or records from the filter database Financial DB1 satisfying the first filter expression (that is, all data entries fitting the age range between 18 to 25). The filtered ID set 1 can comprise a list of hashed identifiers, where each identifies a data entry in the database, or can be a bloom filter or the like.

A bloom filter is commonly applied to test whether an element (e.g. one of the identifiers) is a member of a set. The set is a list of all identifiers and each identifier identifies one or more rows, which might be the database. More specifically, a bloom filter tests whether an element is certainly not present and therefore remove the need to seek elements that don't exist in a set. A query returns a result of either “possibly in set” or “definitely not in set”. A bloom filter is particularly useful if the amount of source data would require an impractically large amount of memory if “conventional” error-free hashing techniques were applied. Moreover, the original used list of hashes cannot be generated from the filter, so it provides another level of anonymity.

The filtered ID set 1 and the second query with the second filter expression X2 is then addressed to the second database 12b of another financial organisation labelled Financial DB2. This database has been identified by the controller as being a good database for extracting income-related data.

The query which is run over the second filter database is a query which matches the second filter expression X2 against only those database entries identified by the filtered ID set 1. This is therefore potentially a faster query to run and might reduce the amount of data to transfer. Moreover, note that there has been no requirement to “join” the records of the first and second filter databases into a common dataset. Thus, these databases can be completely independent, logically and/or geographically and do not have to have any common control or ownership. Note also that no raw data (database records) is expected.

A second filter ID set 2, 32, is returned to the controller 2 following the query which is run on the second filtering database Financial DB2 12b. The controller 2 sends the second filter ID set 2 and the target expression to a target database which it has identified. The result 34 of running the target expression TARGET against the identifiers in the filter dataset 2 (or the bloom filter) is returned to the controller 2. The controller 2 provides the response 10 to the user, which is either raw data or aggregated data as discussed herein.

As an alternative architectural possibility, the first filter ID set 1, 30 and the second filter ID set 2, 32 do not need to be returned to the controller. Instead, they could be passed directly from the first filter database to the second filter database, and from the second filter database to the target database respectively as indicated schematically by the dotted line arrows 36 and 38 moving to the right in FIG. 6.

FIG. 7 is a more detailed architectural diagram illustrating the component at the controller 2 and at a database site 12. The term “database site” is used herein to denote any site where one or more databases may be located. A database may alternatively be referred to herein as a “customer site”, indicating that the database is owned by a particular customer. One distinct advantage of the described embodiments is that searches may be done across multiple databases which may be individually owned by different customers. One such database site is shown in FIG. 7. The public part 4 of the controller 2 comprises a public API 16 which is connected to a database 18 and to a public service module 20 which provides an administration interface 24.

The public API enables the user 8 to interact with the system. The administrator interface interact with an access central layer (ACL) components to set up permission, etc. for individual users.

Public parts 4 of the controller communicate with private components within the private part 6. The private components comprise the Access Control Layer (ACL) component 40, and a control processor 42. The access control layer 40 conditions outgoing requests according to the redaction policies of the querying customer and their subscription status. The processor component 42 is responsible for the processing functions which have been described, and for communication with database sites 12. Each database site comprises a firewall 41 for security purposes. The database site 12 incorporates a database 12a (one of the databases that has already been described). The database 12a is associated with a database agent or drone 50 which is the component which acts to facilitate receipt of queries from the controller 2 and the execution of running those queries over the database 12a.

The database site 12 shown in FIG. 7 has a single database and a single drone. However, there may be a plurality of drones provided for a particular site, each associated with a distinct database. In the present embodiment, there is a 1:1 relationship between drones and databases. The database site 12 comprises an importer module 52. The importer module 52 plays the role of importing data from a “raw” customer database 54 (the origin database) into the database 12a (the mirror database), against which queries can be run. A configuration file 57 can be provided for controlling the operation of the importer. For the sake of completeness, reference numeral 58 denotes a database dump received from the customer database 54, and reference numeral 60 denotes the transfer of that database dump into the database site 12 so that it can be provided to the importer module 52. The configuration file which is supplied to the importer can be manually generated or automatically generated. It defines in particular a set of identifiers which are to be used by the database 12a such that all databases against which queries can be run have at least one common identifier. This could, for example, be personal information such as a name or email address. In addition, certain items of data to populate the data entries may be required by the configuration file. The importer module 52 supplies a configuration file 56 to the drone 50 to inform the drone about the structure of the database 12a (the global schema) against which queries can be run. The structure of a configuration file 56 is shown in FIG. 7a, but note that this does not disclose multiple representations of data as disclosed herein.

As an alternative to a configuration file, to implement multiple representations, a configuration table can be provided as part of the database itself. FIG. 7b illustrates an example configuration table 56a which does specify multiple representations. Some or all of the other fields shown in the example of FIG. 7a may also be present, but in this example only those fields which are modified or added to specify multiple representations are shown, for the sake of clarity. All the fields shown in FIG. 7b may be stored at the mirror database 12 itself. Other fields (e.g. credentials of the user as shown in FIG. 7a) may be set upon start-up of the drones.

In this example, the configuration table 56a specifies that the mirror database 12 stores values according to three representations R1, R2, R3 and that it recognises one key type K1. At least one key and at least two representations are specified in the configuration table 56a.

The representations R1, R2, R3 are stored with a precision indicator (described in more detail below), a category-ID, and a keyflag. The category-ID indicates the category of a given representation (e.g. age, address, income etc.). The keyflag is an optional column indicating whether or not the label is a key K (key.flag=true) or a representation R (key.flag=false). Inclusion of this column allows for the system to quickly identify keys and representations, but this information can also be derived from the label itself (or the inclusion or lack of a precision value). However, this requires parsing a string and is in general slower than using the key flag.

The key K1 is also stored with a representation-ID, a category-ID and a key flag (which in this case is true).

User requests are handled through the public API via the public service module 20 to the control processor 42. The message “analyse request+drones” in FIG. 7 denotes a request from a user to analyse an input query and to identify the appropriate drones to which the split queries should be sent. New drones can be added by the administration interface 24 of the public service module 20. The drone registration process is described below.

As mentioned above, the mirror database 12a is configured to adapt its data entries in order to conform to a particular predefined schema specifying at least two representations according to which each data entry is to be stored. The adapting itself may be performed by the importer module 52, or the importer module 52 may simply forward the “raw” data from the database 54 to the mirror 12a, and the mirror 12a itself or a local processor performs the modification of the data entries.

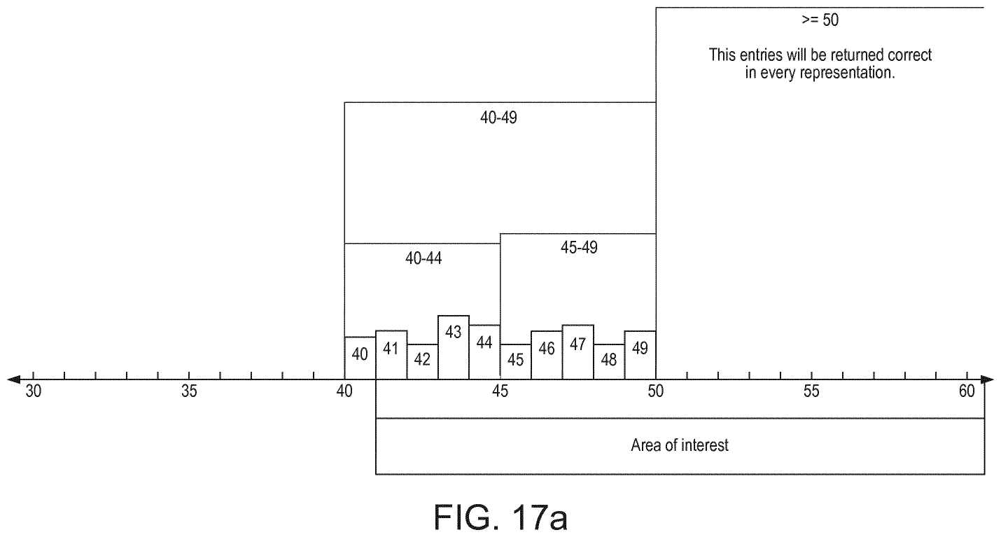

An example of this is shown in FIG. 15 in which a customer database 54 (which is used as the “origin dataset”) contains three data entries 401-403 comprising salary data for three people. The schema using in the mirror 54 (“recipient database”) specifies that salary data should be stored in both of a numerical value (“salary”) and the bin range (“band”) to which it belongs which are, in this example, bands of £5k width. Hence, each of the entries 401-403 is converted to both “salary” and “band” type and stored in mirror 54. Note that conversion to “salary” type comprises a simple copy of the data, as the origin entries are already in this representation.

In this example, “salary” type is more precise than the “band” type as each “band” covers a £5,000 range of possible salaries whereas the “salary” type specifies the actual salary value without any such uncertainty. In other words, the “30 k-35 k” representation of Anna's salary is less precise than “£2,500” because given only the range it is not possible to determine her exact salary—only that it is somewhere between 30 k and 35 k. Note that for some applications (some types of query) this may be sufficient. For example, for a query requesting data entries with a salary value of 30 k or over it does not matter that the exact salary is not derivable from the range—because all possible values satisfy the query.

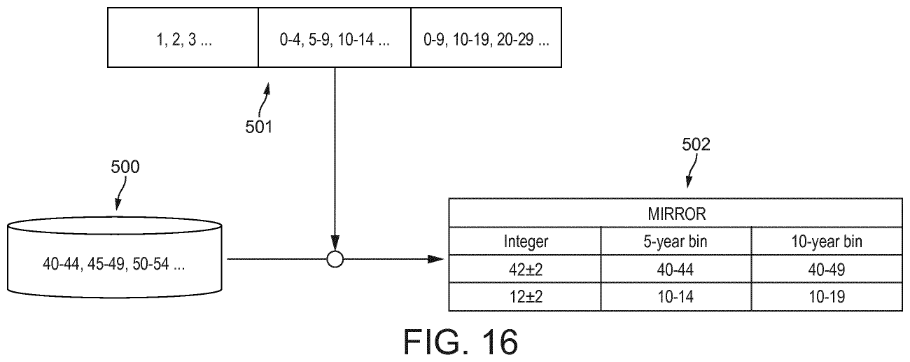

It is understood that the customer database 54 and the mirror database 12a (the database which is actually queried) form a database-mirror pair, the mirror conforming to a global schema. Multiple database-mirror pairs may be present, as shown in FIG. 14.

In FIG. 14, three dataset-mirror pairs are shown: dataset A with corresponding mirror A′; dataset B with corresponding mirror B′; and dataset C with corresponding mirror C′. Each pair is located at a different site (e.g. a different physical location such as a different data centre). Note that “dataset” refers to any source of data, which may or may not be stored on a single database. That is, a “dataset” may comprise data which is in fact sourced from multiple databases (e.g. multiple different servers). In this example it is assumed that the datasets A-C come from a single respective database and therefore these terms can be used interchangeably.

The mirrors A′-C′ are configured, as mentioned above, to receive data entries from their respective database A-C and store them in a manner which conforms to a global schema. The mirrors A′-C′ may be “passive” in that they receive data entries forwarded from their respective database A-C, or may be “active” in that they poll their respective database for changes to the data stored therein. The polling may be performed according to any known data polling technique and therefore it is understood that the mirror may poll the (origin) database only once, or multiple times such as at a predetermined or adaptable polling frequency.

The representation of the data as present in the source dataset may be called an “origin format” or “source format”.

The global schema 501 defines, for some data types such as age or salary, multiple representations, each data item (entry) being stored in all of the representations for each data entry in the respective mirror. Each origin data set A-C may have one matching representation in the mirror, and generate other representations—or may need to convert from its representation to multiple different representations. That is, the source format of the data may or may not match one of the representations demanded by the global schema 501.

In the example of FIG. 14, the schema 501 defines particular representations for data entries in the mirrors A′-C′. Each mirror A′-C′ is configured to apply the same global schema. The advantages of the global schema are realised when querying the mirrors with one or more queries, which is described in more detail below. Hence, it is understood that the “global schema” (and the schema in general when only one mirror is present) may specify any two or more data formats (representations) in which data may be stored which facilitates querying.

In the particular example shown in FIG. 14, the global schema 501 defines that data entries relating to ages are to be stored as each of three representations:
Rep-1: an integer value of the number of years old that person is.
Rep-2: a range of (inclusively) five years taken from 20-24, 25-29 etc.
Rep-3: a range of (inclusively) ten years taken from 20-29, 30-39 etc.

Hence, the following modifications are made to the data when compiling the mirrors:
Entries in database A are in a source format of two-year bins (i.e. 22-23, 24-25 etc.).
   These are converted to rep-1 by picking a representative value from the bin. That is, for example, the format “26-27” is not “allowed” by the mirror (at least not for rep-1) and so a value which is allowed needs to be chosen—the lower value in this example. The precision indicator for these is 50% which captures the fact that one of two possible values was chosen. Note that if the global schema allowed half-integer values, the midpoint (26.5) could have been chosen.
   These are converted to rep-2 by picking a representative “allowed” range from rep-2 as specified in the global schema 501. In some cases (e.g. Anna 101 Bob 102) it is possible to determine this is 100% certainty because all possible age values in the source format range map to the same range in rep-2. In some cases this is not possible (e.g. Charlie 103) and hence a single range is chosen, and the precision indicator is accordingly lower than 100%. In this case the precision is 90% because the source format (24-25) has to be normalised into two possible rep-2 ranges (20-24, 25-29).
   Example: Let 20 people be 20-21, 20 people be 22-23 and 20 people be 24-25. Normalising those values to range 1 (20-24) will be done by adding all people who are 20-21 and 22-23 to this range. The people who are 24-25 will be evenly (or depending on general age distribution) split in the buckets 20-24 and 25-29. The error done by this split is ˜50%. So that 5 of the 10 people added from 24-25 are presumably wrong. The bucket 20-24 would contain 50 people. Therefore the precision is 45/50=90%.
   These are converted to rep-3 by picking a representative “allowed” range from rep-3 as specified in the global schema 501. Similar concepts apply to the above, but in this example case it is possible to determine with 100% precision into which rep-3 range each of Anna 101, Bob 102, and Charlie 103 fall. Hence, the precision indicators are all 100%.
Entries in database B are stored in a source format of five-year ranges (20-24, 25-29 etc.)
   These are converted to rep-1 by selecting a midpoint integer value, similarly to above. In these cases, the precision indicator is 20% because the selected integer value is just one of five possible values. For example, Dennis 201 could be ages 20, 21, 22, 23, or 24, but is stored in rep-1 in Mirror B′ as only “22”.
   The source format of Dennis's 201, Edward's 202, and Fran's 203 ages matches the representation of rep-2 and therefore no conversion is required. The precision indicator is accordingly 100% for each of these.
   The entries can also be converted to rep-3 with 100% precision because each entry 201-203 unambiguously maps to a rep-3 range.
Entries in database C are in a source format which simply specifies the date of birth of the person. This source format allows for 100% precision conversion to each of the representations in the global schema 501, as shown in FIG. 14.

It is understood that “age” is used only as an example here, and that the described techniques are readily applicable to any data values such as financial values, dates, etc.

Whichever criteria are specified in the global schema, the global schema may specify that one or more of these are to be applied to all the data entries or only to some of the data entries. For example, the global schema may dictate that keys defining personal information such as names be stored in a hashed form, for privacy purposes.

It is understood, based on the above, that each mirror A′-C′ is generated separately at its respective site. The only shared information required is that of the global schema 501 which could be, for example, provided by a third party or central administration system.

Continuing the age range example, it is noted that an origin database may store age data in different age ranges (i.e. different bins, having different lower and/or upper bounds) from those which the global schema requires. For example, data entry 202 in FIG. 14 specifies that Edward is in the age range 25-29. However, consider a possible global schema which requires age ranges to be one of: 18-21, 22-25, 26-29, 30-33 etc. In this case, the age range of the schema with the most overlap with the age range of the data entry could be chosen—26-29 in this example, and stored with a precision indicator representing that lost information (age=25).

Similar considerations apply with respect to any values which can be stored in “bins” (predefined ranges), such as numerical values, the salary data given in FIG. 15 being a further example thereof.

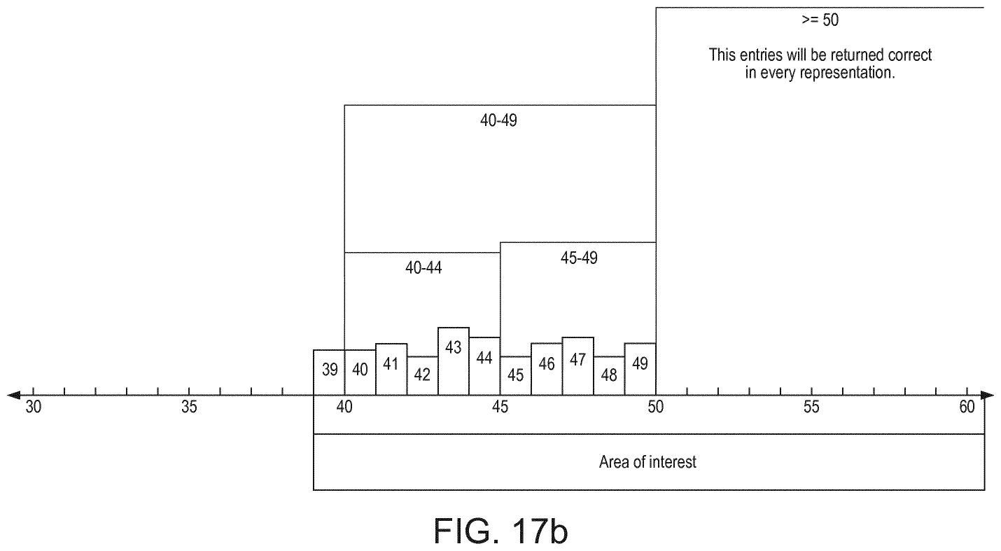

FIG. 16 shows an example of an alternative representation of precision indicators. The source dataset 500 has values in ranges 40-44, 45-49 etc., which might represent ages or people, and the global schema 501 specifies three representations: single integer value; 5-year bin (10-14, 15-19 etc.); 10-year bin (10-19, 20-29 etc.). When the data entries are moved to the mirror 502, the resulting mirror entries of the first representation are not 100% precise because they will be converted from a range which covers five values into a single value. This can be done by converting them into the average (midpoint) value (e.g. 40-44 becomes 42, 45-49 becomes 47 etc.). These entries in the mirror will be stored along with a “precision indicator” which this time is shown as an explicit error size (e.g. a standard deviation, or variance). Note that the mirror 502 in FIG. 16 shows only two data entries as examples.

The other two representations in the mirror 502, on the other hand, are 100% precise because no such uncertainty arises. That is, each value in the source dataset 500 can unambiguously be assigned a value of both the second and third representation. In this example, a precision indicator is simply omitted from these entries (rather than stating “100%”, as in the previous example).

Note that the terminology used here is that information is lost when transforming e.g. 40-44 into 40-49 (as the new range covers some values which were not by the original), and accuracy is lost when transforming e.g. 40-44 to 42 (as the real value of the data may not in fact be 42).

As mentioned, the schema 501 specifies more than one format to which the data entries should be converted and stored in the mirror 12. This is particularly advantageous as it allows a query on the mirror 12 to be selectively run over a particular format which is suited to the query. This is explained in more detail below in relation to the embodiment shown in FIG. 14.

When control processor 42 receives a query to be run over a mirror 12a (i.e. one of A′-C′), it may be possible to determine which representation (integer age value, age range, D.O.B) best suits the query and to run the query over that particular one. Whether or not this is possible depends on the structure of the query itself. If it is not possible, then the query can be run against a default one of the representations (e.g. the most specific one, being the one with the smallest error values) such as D.O.B. in this example as it is the data type which most accurately specifies an age.

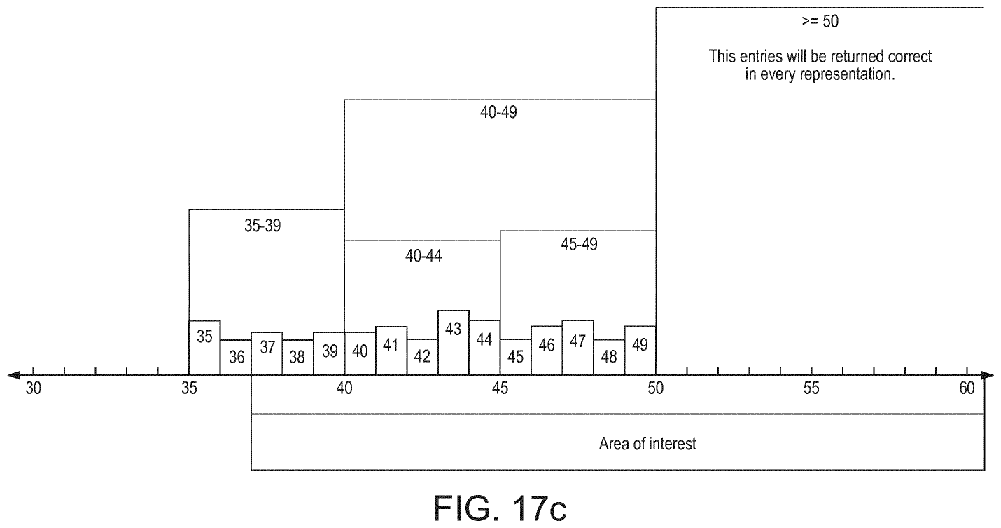

With reference to FIG. 14 and FIG. 17a, consider a query for entries matching an expression “age>40”. For example, this might be run in order to examine other data (not shown) attached to each entry such as salary data for each person.

The term “accuracy” is used herein to identify the (likely) error rate of using a particular representation when running a query. Hence, a particular application of a query to a particular representation is less “accurate” if it returns a higher number of false positives. This will become clearer in the following description.

Running this query over rep-1 will be 100% accurate, as it is always possible to determine whether or not a given person satisfies the query (is older than 40) based on the rep-1 value. Note that this is a separate point from the term “precision” earlier which referred to the certainty on the representation itself.

Running this query over rep-2 will likely not be 100% accurate, because entries (not shown in FIG. 14) in the 40-44 value of rep-2 include both some people who satisfy the query (older than 40) and some who do not (aged 40 exactly). The actual accuracy will depend on the particular data in question.

Running this query over rep-3 will again likely not be 100%, and in fact renders the same accuracy as rep-2, false positives for age=40.

The control processor 42 must determine which representation of the data to use for each mirror A′-C′ when running the query over that respective mirror. This may involve using the representation with the highest overall (e.g. sum or average) accuracy. In this specific example, note that rep-1 is preferable for running the query (age>40) because it is the only representation which allows this specific cut-off age. That is, the other two representations will necessarily (probably) include some people who are age 40, as these representations do not distinguish between age 40 and age 41. If rep-1 has, overall, low precision indicators however, it may be preferable to use one of the other representations despite this.

Mirror A′: Rep-3 is preferably used for the query because the average accuracy is highest of the three representations and the total precision of the entries is highest. The control processor 42 sends query “age_rep3>=40-49” to mirror A′, which will return all people aged 40 or over. The original query requested people aged 41 or over and so there is some error here, the size of which will depend on the particular data present. This error can be indicated to the user.

Mirror B′: Rep-2 or Rep 3 could be used for the query. The control processor 42 sends query “age_rep2>=40-45” to mirror B′ which will return all people aged 40 or over. The error on this will hence also be non-zero, and will depend on the data actually present in mirror B′.

Mirror C′: Rep-1 is preferably used for the query. As mentioned above, rep-1 is preferable in general for this query, and in this case the precision on each of the entries is sufficiently high (e.g. over 99%) that the control processor 42 may determine to use it rather than relying on a less accurate, but more precise representation, as before.

With reference to FIG. 17b, consider the query expression age>38 instead of age>40, with a range representation. For Rep-1 there is no error. For Rep-2 and 3, the system would not include ranges 35-39 or 30-39. In this case, people over the age of 40 would not be returned as false positives, but would not return people aged 39, resulting in some false negatives.

With reference to FIG. 17c, consider query age>36. With Rep-1, there is no error with Rep-2 there are false positives 35, 36 when 35-39 is included. With Rep-3, there are false negatives 37, 38, 39 when 30-39 is not included.

Given the above, it is understood that the particular representation to use is a trade-off between using an accurate representation for the querying in question, and not using a representation which incurred large imprecisions which being generated from the source format.

In summary, a recipient database (mirror) can be constructed from any data source arriving in any format. Different origin data sources will not necessarily have the same representations for the same category of data. Therefore, the techniques described above provide for compiling of a recipient database (mirror) in which different representations of the data are stored in certain categories. Each different representation actually provides different information, and therefore there is a potential for information loss between the origin set of entries and its mirror. A global schema defines, for each category, a set of multiple representations for storing data in that category. For each category, multiple representations of the “same” data are stored.

As one concrete example, an age might be stored as a single value, a range of values, or in a field having a greater than or less than indicator. Other types of data are salary data (which can similarly be stored with the representations as for age), and gender data where one representation could perhaps have five different genders, and another representation could perhaps have ten different genders. Each representation has a different precision. When converting from the source format in the origin set of data to the representations in the mirror database as prescribed by the global schema, some uncertainty may arise (see examples given earlier). A precision indicator is stored in association with each representation.

When an input query comes in (either from a user or from an automated query source) it is split into individual queries, each query having an expression (e.g. “age>40”, see examples above). The format of the expression in a particular category is converted into one of the representations of the global schema. An accuracy indicator is associated with each conversion. In principle, the representation which will then be used to run the queries is the one with the highest accuracy from the original conversion which still matches a global schema. However, when running the query, it may be that to use that particular representation would result in queries attempting to access representations of databases which themselves have very low precision indicators. In such a case it might be preferable to use a different representation of the original query format.

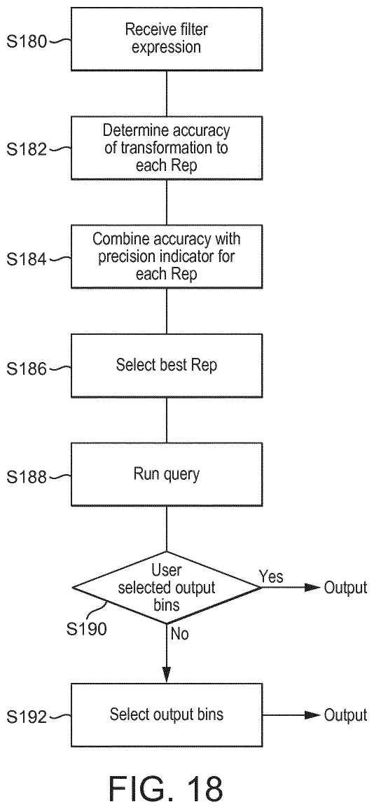

FIG. 18 is a flowchart of the querying process. Note that this takes place at the database, and if there is an activity carried out at the database between step S6 and S7 indicated in FIG. 5 which are carried out on the control side.

At step S180 the filter expression is received. At step S182 the filter expression is transformed into each representation available in the mirror database which is to be queried. The accuracy of each transformation is recorded. The accuracy of each transformation is then combined with the precision indicator which is stored in the mirror with each representation. At S186 the best representation to use for the query is selected based on a combination of the accuracy of transformation and the precision indicator. This could be by multiplying the transformation and accuracy of transformation with the precision indicator, or by some other mathematical function. Once the best representation has been selected in step S188 the query is run. There is also a step of selecting how to represent the aggregated results from the query in respective bins. It can be useful if these bins somehow match the bins of the representations which were used to run the query, although this is not absolutely necessary. According to one option, a user may select the output bins that he requires for his query, and the results of the query are sorted accordingly. At step S190 it is determined whether a user has selected the output bins, and if he has, the aggregated results of the query are output in the user selected bins. If he has not, at step S192 the processor itself automatically selects suitable output bins, and in doing so it can select bin boundaries which match up to the representations which were used for the query. Once the output bins have been selected, the aggregate results are output in those bins.

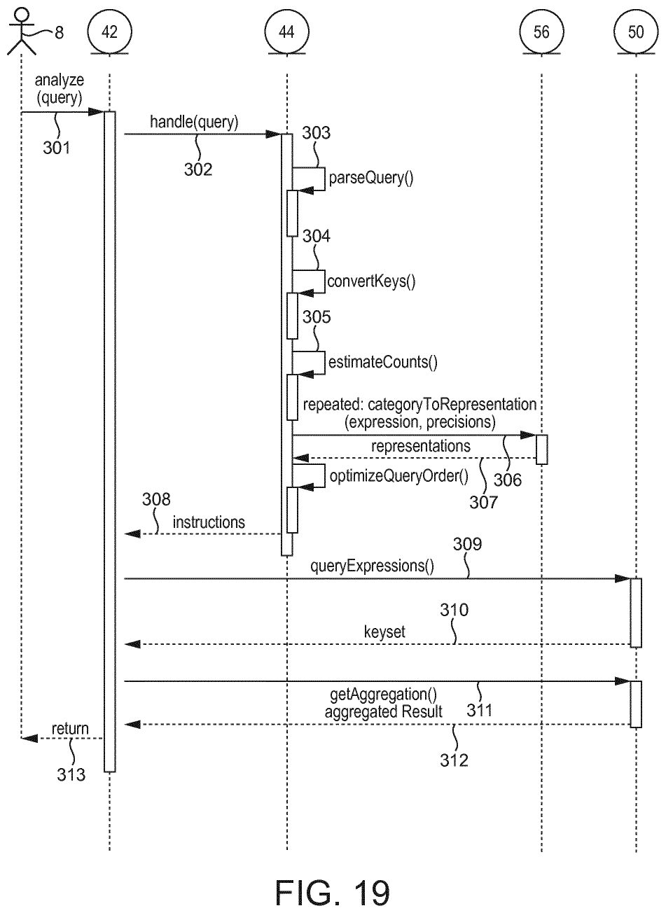

FIG. 19 shows a diagram illustrating an overview of the flow within the system architecture for applying a query to multiple datasets to return a result. This puts the inventive aspects described in the present application into a broader use context. For example, to run a query for salary data for people aged 41 and above (e.g. salary:age>40): a first dataset having age values but no salary data can be used to identify names (as an example of a key) of people who are older than 40; these names are then provided to a second dataset having salary data but not age values in order to return the salary data of those people previously identified using the first dataset (who are therefore over 40).

The datasets used (the multiple datasets above) can be determined based on intersection data between datasets. For example, respective indications of intersections between a user's dataset and each of a plurality of further datasets may be determined.

A higher intersection means it is more likely that a given entry, as identified by a key such as name, is present in both datasets (i.e. that a given entry from the user's dataset is in the respective further dataset). A further dataset having a higher intersection with the user's dataset than another dataset therefore contains more data entries with keys matching a key from the user's dataset than the other dataset. Therefore, the intersection value(s) may be presented to the user 8 for the user to select which dataset(s) he wishes to run his query over. Alternatively, a dataset pair having the highest intersection may be automatically selected.

The query is input, for example by the user 8 entering the query via the public API 16 and received by the control processor 42 with a request 301 to analyse the query. The input query is then analysed to determine one or more datasets to which the query should be applied. This involves analysing the expressions of the query in order to determine at least one dataset having relevant data (e.g. an expression “age>40” requires a dataset comprising age data).

The analysed query is then passed to a drone graph service 44a with a request 302 to handle the query. The drone graph service 44a comprises the drone graph 44 enabled with some processing functionality. That is, the drone graph service 44a comprises the drone graph 44 and a processor (not shown) for performing operations on the drone graph 44 (e.g. create, read, update, delete operations) including at least those described herein.

The drone graph service 44a parses the query—303 (this may be performed by a dedicated parser separate from the processor). After parsing the query, the drone graph 44 itself is used by the processor of the drone graph service 44a to convert 304 keys of one dataset into a type recognisable by the other dataset (e.g. if the first dataset uses names of people and the second dataset uses email addresses, then an intermediate mapping entity storing associations between names and email addresses is used to either convert names to email addresses of vice versa).

The drone graph service 44a then estimates 305 the size of the query based on statistical data about the datasets (e.g. percentiles of numeric values, most common values for text or Boolean values etc.).

In step 306, data categories in the query are analysed by the drone graph service 44a to optimise a match between a representation of that category in the query and an available representation in the dataset. The dataset may store data of a particular category according to more than one representation. That is, the configuration file 56 of a particular drone may specify multiple representations of a data value in a certain category, to enable better matching with an input query. The representations which are available are returned 307 to the drone graph service 44a. The drone graph service 44a selects which representation is to be used based on maximising an expected returned query size. At step 308, the drone graph service 44a returns instructions to the control processor 42 to use the selected representation.

The query is then run over this pair of datasets by the control processor 42 using the representation indicated in the instructions of step 308. The first dataset is accessed 309 (represented here by drone 50) using an expression of the query (e.g. age>40) to generate a set of keys (“keyset”) being the keys which represent data entries satisfying the expression (e.g. a set of names of people aged over 40 in the first dataset).

This keyset is returned 310 by the drone 50 to the control processor 42 which then provides 311 the keyset and the querying expression to the second dataset (also represented by drone 50 in FIG. 19) to aggregate data entries from the second data set. This comprises the drone of the second dataset determining entries of the second dataset having keys which match a key of the keyset and aggregating the values according to the querying expression. For example, the querying expression may be for salary data in which case the drone 50 aggregates salary data for those people in the second dataset who are identified in the keyset provided in step 311. The result (e.g. salary data for people over 40 years of age) is then returned 312 to the control processor 42 which can then provide 313 the result to the user 8.

### Drone Registration Process

When a new database is to be added to the system, a new drone 50 is initiated at the location (e.g. customer site) of the database. An administrator at the controller 2 manually instigates a new drone registration process which contacts the new drone to cause the new drone to issue a registration request. The administrator adds a drone and gets a JWT (text) and supplies this text to someone who uses this text at the customer site 12. When the drone starts it sends a request including the JWT to the public API 16. On success the response contains a certificate which the drone needs for communication between 42 and 50, and a drone identifier. Drone identifiers are held in a graph 44 at the controller 2. The list can be made accessible to customer with access constraints. The drone identifier identifies the drone and its location address to enable queries to be sent to it. Each drone has an association with its database at the customer site. The drone ID also indicates the attributes available to be searched in the mirror database 12 associated with that drone.

As mentioned above, in the response that is returned to a requesting user, the raw set of data entries which have been identified as a result of the multiple queries executed across multiple databases may be returned. Alternatively, the entries can be aggregated into groups according to attributes of the entries. For example, the groups could comprise statistical bins, each bin containing result entries with attributes in a defined parameter range for that attribute. The aggregated data is supplied to a user.

To increase anonymization (that is to decrease the likelihood of a particular data entry in a sparse set being able to be tied to a particular individual who could be identified) a redaction threshold can be applied of a minimum number of entries per bin. Another redaction threshold for entries in all bins could also or alternatively be applied, e.g. “small” bins can be removed.

As mentioned above, the embodiments described herein enable results across a number of different databases to be returned in response to a single query, in a manner which is “hidden” from a requesting user. Moreover, there is no need to join the records of the databases into a common dataset, so there is no requirement for the databases to be under any kind of common control or ownership.

The databases may be at separate geographical locations. The databases may be at separate IP addresses.

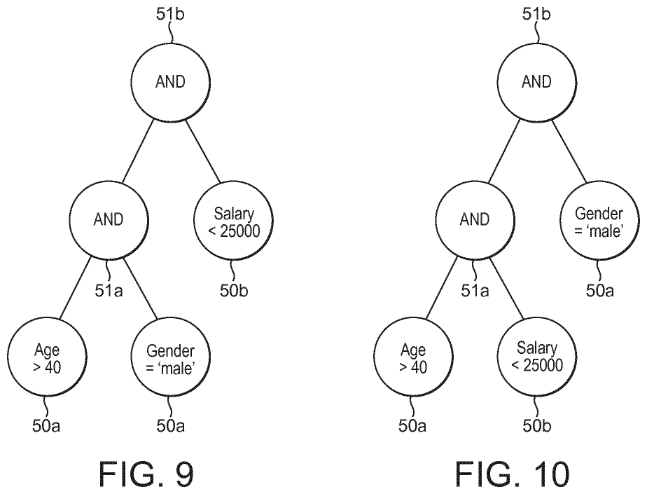

FIG. 8 to FIG. 10 exemplifies the process of querying multiple drones using a single joining key. For example, a combination of filtering expressions A=1 AND B=2 is shown in FIG. 8a to illustrate the use of an “AND” operator 51 for cross examining returned results at the drones 50a, 50b. Wherein an extra filter expression C=3 at drone 50c can be added and the filtering expressions may be represented as a tree in FIG. 8b, i.e. A=1 AND B=2 AND C=3. Each of the drones 50a, 50b and 50c is appropriated with a respective independent database.

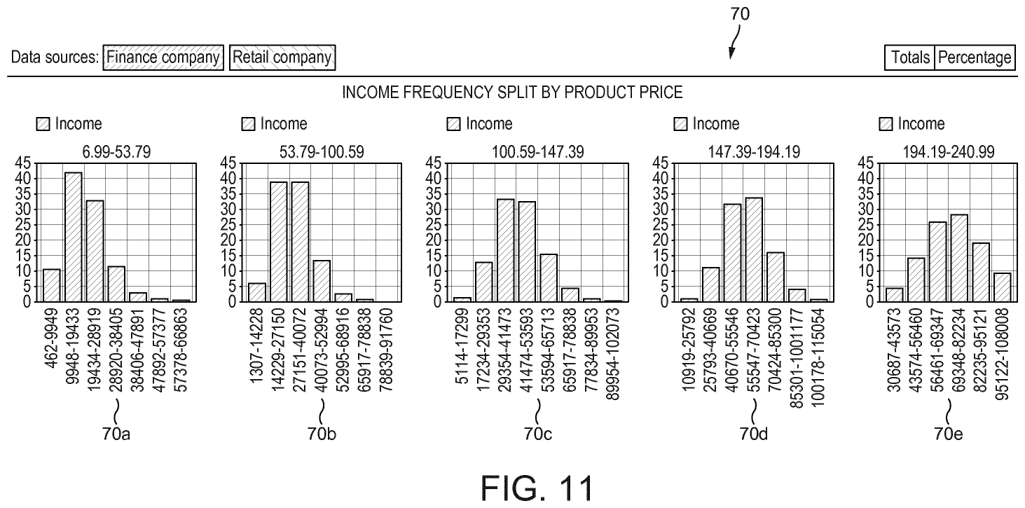

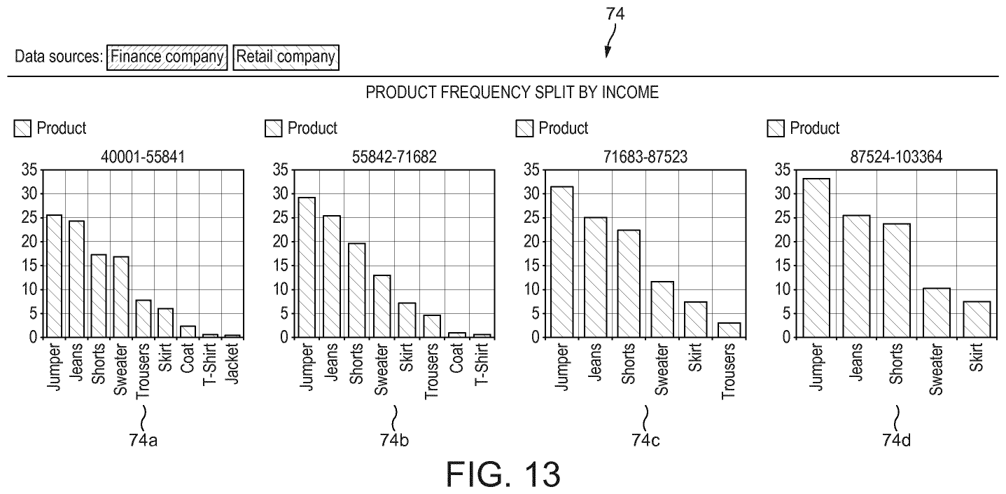

In FIG. 9, the expressions A, B and C in FIG. 11b are replaced with actual filtering expressions (Age>40), (Gender=“male”) and (salary <25000). In this particular example, drone 50a contains both age and gender information and drone 50b contains salary information. Since the filtering expressions (Age>40) and (Gender=“male”) are both operable using a common operator (AND) 51a at drone 50a, they can be operated using a single query (“age>40 and gender=“male”).

In a first scenario where neither drones 50a nor 50b is the target drone, they both count the number of entries fitting their respective filtering expression, as follow,

Count (“age>40 and gender=“male”) in drone 50a; and
Count (“salary <25000”) in drone 50b;

Assuming the count is relatively lower in drone 50a than that in drone 50b, the two drones then carry out filtering and each returns a filtering set, as follow, Query (“age>40 and gender=“male”) in drone 50a and return filtering ID set S1; and Query (“salary <25000” and filtering set ID set 1) in drone 50b and return filtering ID set S2 which returns a filtering ID set S2 at most the same amount of elements than in the filtering ID set S1.;

The return filtering ID set S2, which has a higher count, is then sent to the target drone for generating the distribution.

In a second scenario where drone 50b is the target drone, no counting is required at the drones 50a and 50b, since drone 50b will be used to generate the distribution, e.g. the operation comprising the step of Query (“age>40 and gender=“male”) in drone 50a to return filtering set S1, and subsequently sending filtering expression (“salary<25000”) and said filtering set S1 to drone 50b to generate the distribution.

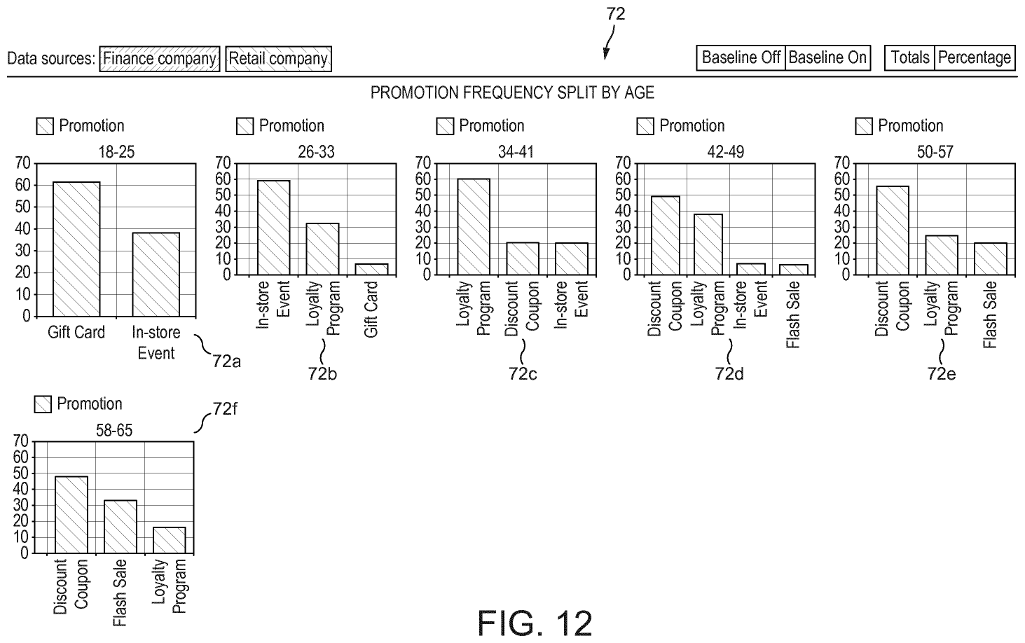

A third scenario is shown in FIG. 10 where the scenario (A+B) and C is changed to (A+C) and B. The query comprises the filtering expression to “(Age>40 and gender=‘male’) and salary<25000”. The process is equivalent to that of the first scenario.

Example queries have the following form:

Target expression WHERE filter expression.

FIG. 11 shows an example output of a user screen 70 for a user which has requested to join data from a finance company and a retail company.

The query Q1 underlying this is:

### Distribution (Income) WHERE Distribution (Product Price)

The data shown in the bar graphs 70a-70e in FIG. 11 is income data which shows the number of people having income in certain ranges derived from a finance company. The numerical range on each bar graph differs and represents a product price range derived from the retail company.

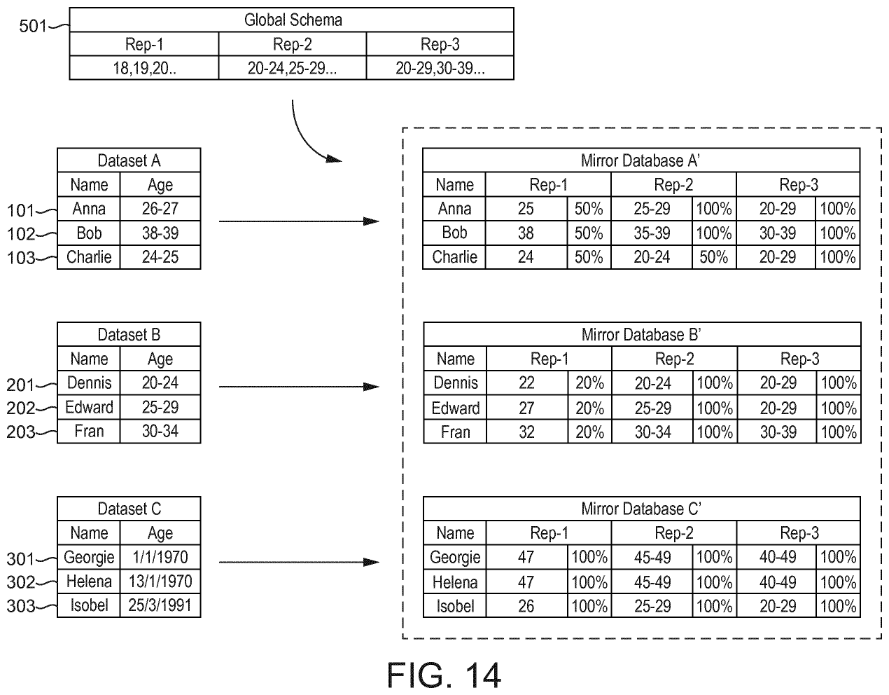

FIG. 12 shows another example. In this example the data from the finance company indicates numbers of people in certain age range with certain income bracket, which is used to provide different bar graphs 72a-70f from the retail company concerning promotion types.

The query Q2 underlying this is:

Distribution (Promotion) WHERE (Distribution (Age) WHERE income>60000)

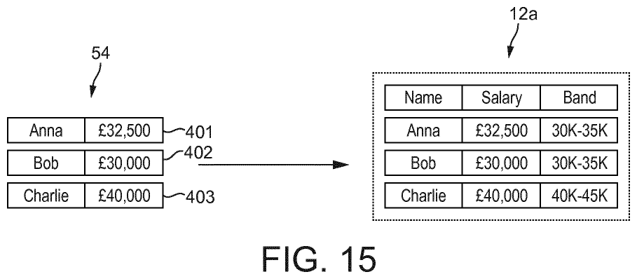

FIG. 13 shows another example where the data from the finance company is used to provide income ranges which are used to generate bar graphs 74a-70d of product frequency from the retail company.

The query Q3 underlying this is:

Distribution (Product) WHERE (Distribution (income) WHERE income>40000 and product_price>80)

Some examples of filter expressions and their use are illustrated in the following table.

| Filter expression | Example use |
|---|---|
| Operator | age > 40, Age >= 40, town = “London” |
| (>, >=, =, !=, <, <=) | |
| Operator between | age between 25 and 30, town between “a” and “b” |
| Operator in | age in (15, 16, 24, 25), |
| | postcode in (“RG21 1CE”, “RG21 1CD”) |
| Operator like | postcode like “RG21%” |
| Negated | Not age > 40 |
| Combined via AND | age > 40 and age > 50, town > “a” and town < “b” |
| Combined via OR | age > 60 or age < 15 |

These example filter expressions may be applied to form the following example queries:
distribution (income) where (distribution (gender) where (distribution (age) where job_status !=‘unemployed’)), represents “how is income distributed over genders and ages for not unemployed people”.
distribution (private_health_insurance) where (distribution(age) where (distribution(visits_to_doctor) where age >50 and (income >45000 or retired=true))), represents “how many people have a private health insurance when they are over 50 and earn more than £45000 or are retired” The results are split up into 2 groups that is “age” and “visit_to_doctor” group“.
sum(purchases) where (distribution(purchase_method) where (distribution(town) where (distribution)purchase_month and purchase_time>‘28-10-2015’) where age between 18 and 29 and gender=‘female”, represents “how much money have young females spend on purchases split up in the towns they live in, the month they made the purchase, and the method they used in the last 12 months”.

As mentioned above, the importer module 52 defines the identifiers which will be used in common between the databases. Although it may be desirable to have identifiers which uniquely identify particular entries, it is not necessary for implementation of the concept described herein. It is anticipated that there may be errors where identifiers do not uniquely identify an individual entry, for example, customers having the same first and last names, or a single customer having multiple email addresses. However, error rates in aggregation may be acceptable in some cases. If error rates are not acceptable, mechanisms could be put in place to improve the accuracy, or to triage the identifiers to make sure they are unique.

It is noted that different customer databases may adopt different column headers for the same expression, therefore the importer module can be arranged to carry out normalisation on the column headers so as to produce a unified category (or identifier) for a given expression. The normalised data are exported from the “normal” database 54 to the database 12a against which queries will be run, the database 12a constituting an intermediate recipient database for the purpose of running the queries. It is possible to share high level data statistics between the databases once normalisation is finished, or while the database is being normalised. Normalisation can be carried out manually or automatically.

1. A method of compiling a database of entries, the method comprising:
(a) receiving an origin set of data entries from an origin dataset, each entry comprising a category indicator and at least one data field containing data of a first category in a first source format;
(b) for each entry of the data of the first category, transforming the source format into at least one representation which represents the data of the first category with a different precision to the source format; and
(c) storing the data entries in a recipient database, each data entry comprising the category indicator and multiple representations of the data, including the at least one transformed representation.

2. The method of claim 1, wherein the multiple representations are predefined as part of a global schema for compiling several recipient databases, wherein the first category of data is provided in the multiple representations in each of the recipient databases.

3. The method of claim 2, wherein each recipient database is compiled from its own respective origin set of data entries.

4. The method of claim 2 or 3, wherein the multiple representations of the data in the recipient database includes the source format.

5. The method of claim 1, 2 or 3 wherein none of the multiple representation of the data in the recipient database matches the source format.

6. The method of any preceding claim, wherein the different precision is a lower level of precision, and data entries stored in the recipient database according to the multiple representations are stored in association with a precision indicator for each representation.

7. The method of any preceding claim, wherein the at least one category indicator comprises an age field and the multiple representations comprise at least some of:
a range of values;
a minimum or maximum threshold; and
a single age value.

8. The method of claims 1 to 6, wherein the multiple representations comprise multiple different ranges.

9. The method of any of claims 1 to 6, the category indicator comprises a salary field.

10. The method of any of claims 1 to 6, wherein the multiple representations include an indication of the data entry value as a floating point or integer number.

11. The method of any of claims 1 to 6, wherein the multiple representations include an indication of whether the data entry is greater than or less than a threshold value.

12. The method of any claims 1 to 6, wherein the multiple representations include an indication of a range of values within which the data entry lies.

13. A computer configured to compile a database of entries, the computer comprising a processor arranged to execute a computer program which, when executed by the processor, carries out a method according to any one of claims 1 to 12.

14. A computer according to claim 13 comprising a memory in which is stored a configuration file defining a global schema which defines the multiple representations.

15. A database comprising computer memory holding a data structure in the form of a plurality of data entries for respective entities, the data entries having been transformed from an origin data set, wherein each data entry comprises a category indicator indicating a category of data in a data entry, and multiple representations of the data in that category, including at least one representation transformed from but not matching data in that category in the origin dataset, each representation stored with a precision indicator denoting the relative precision of the representation compared with the data in that category in the origin dataset.

16. A method of querying a database according to claim 15, the method comprising:
extracting an expression from an input query, the expression having a query format and pertaining to a category;
selecting one of the multiple representations in that category; and
comparing the expression with the data in that category for the data entries; and
generating an output of entities where the data in that representation of the data category matches the expression.

17. A method according to claim 16 comprising the step of transforming the expression into each of the multiple representations and determining an accuracy of transformation for each representation, where in the step of selecting the one of the multiple representations comprises using the precision indicator for that representation and the accuracy of transformation of the input query expressions.

18. A method according to claim 16 or 17 when the step of generating outputs comprises generating data in respective bins, wherein the boundaries of the bins are selected based on the selected representation.

19. A method according to claim 16 or 17, wherein a user who provided the input query selects bin boundaries for aggregating output results of the query.

20. A method according to any of claims 16 to 19 further comprising proceeding with the query if a precision indicator associated with the selected representation is below a threshold value and otherwise not proceeding with the query.

21. A method according to any of claims 16 to 20 comprising returning results based on the selected representation of the multiple representations, with an error indicator based on the precision indicator of the most closely matched representation.
